(19) United States
(12) Patent Application Publication
(10) Pub. No.: US 2016/0031265 A1
(43) Pub. Date: Feb. 4, 2016

(54) Axle Body and Chassis Unit

(71) Applicant: SAF-HOLLAND GMBH, Bessenbach (DE)

(72) Inventor: Olaf Drewes, Aschaffenburg (DE)

(21) Appl. No.: 14/779,484

(22) PCT Filed: Apr. 9, 2014
(86) PCT No.: PCT/EP2014/057124

§ 371 Date: Sep. 23, 2015

(30) Foreign Application Priority Data
Apr. 23, 2013 (DE) 102013207314.3

(51) Int. Cl. B60B 35/08; B60B 35/02; B60B 35/04

(52) U.S. Cl. CPC B60B 35/08; B60B 35/04; B60B 35/025; B60B 2900/111; B60B 2900/351

(57) ABSTRACT

The present invention relates to an axle body for use in motor vehicles and to a chassis unit having an axle body of said type comprising an axle tube and an axle stub, wherein the axle tube is in the form of a hollow body and has a plane-symmetrical first section, wherein the axle tube has a second section which is of asymmetrical design with respect to one of the planes of symmetry of the first section, and wherein the axle stub is arranged at a distal, rotationally symmetrical end of the axle tube.

### BACKGROUND OF THE INVENTION

The present invention relates to an axle body as well as a chassis unit of a motor vehicle, preferably a commercial vehicle or utility vehicle.

Such axle bodies are well known in the prior art. Here, it is particularly wide-spread to design the axle body as a hollow body extending substantially evenly along a longitudinal axis. The design as a hollow body prevails particularly with regard to the bending strength and torsional strength of the axle body when compared to a solid-body axle, since a hollow-body axle may achieve a considerably greater bending strength and torsional strength while the weight remains the same. The bending strength and torsional strength of an axle depend in particular on the design of the cross-section. Up to now, it has not yet been possible to use an optimal cross-section design of axle bodies known in the prior art since such a design of the axle body regularly collides with the installation space limits in the chassis area of a commercial vehicle. At the same time, it has up to now been necessary to use for commercial vehicles of different weight classes and accordingly different installation space conditions in the chassis area respective individual axle bodies manufactured for the respective type of commercial vehicle only, resulting in a plurality of axle body models to be provided. In view of the given installation space conditions in the chassis area, there is therefore an urgent need to optimize an axle body both with regard to the weight thereof and with regard to the manifold usability in different commercial vehicle models.

The object underlying the present invention is to provide an axle body, which allows for a reduction in weight while being usable in a more versatile manner than the axle systems known in the prior art.

This object is achieved by means of an axle body according to independent claim 1 as well as a chassis unit according to independent claim 13. Further advantages and features of the invention become apparent from the dependent claims.

### SUMMARY OF THE INVENTION

According to the invention, the axle body comprises an axle tube and an axle stub, wherein the axle tube is in the form of a hollow body and has a plane-symmetrical first section, wherein the axle tube has a second section which is of asymmetrical design with respect to one of the planes of symmetry of the first section, and wherein the axle stub is arranged at a distal, rotationally symmetrical end of the axle body. The axle body is preferably the rigid axle of a commercial vehicle and comprises the two components axle tube and at least one axle stub. The axle tube extends substantially along a longitudinal axis, which is preferably simultaneously the axis of rotation of the axle stub. Preferably, the axle tube can be or is fixed to a longitudinal control arm of the chassis of the motor vehicle or of the commercial vehicle and serves to transmit force from the axle stub to the chassis of the commercial vehicle and vice versa, wherein preferably a vehicle wheel can be mounted rotatably on the axle stub. The axle tube has a first section, which is of plane-symmetrical design. To put it differently, preferably, the cross-section of the first section is formed in an intersection plane perpendicular to the longitudinal axis in such a manner that it is plane-symmetrical to a plane of symmetry. Here, the at least one plane of symmetry of the first section is arranged such that the longitudinal axis of the axle tube is in said plane of symmetry, wherein the first section of the axle tube is designed mirror-symmetrical to said plane. Furthermore, it is preferred that the first section is designed in a plurality of cross-sections arranged along the longitudinal axis such that it is plane-symmetrical in the described manner. Preferably, the first section of the axle tube has a substantially polygonal cross-section, wherein, however, roundings or curves are preferably provided at the respective corners of the polygonal geometry. Furthermore, the axle tube has a second section, which is of asymmetrical design with respect to one plane of symmetry of the first section. Preferably, over the course of the outer contour of the axle tube along the longitudinal axis, the second section forms a recess or a depression or, to put it differently, a cavity in the otherwise even outer geometry of the axle tube. The second section serves in particular to avoid a contact between the axle tube and adjacent peripheral systems of the chassis unit. To put it differently, the second section of the axle tube is provided in order to integrate an axle tube with a comparatively large cross-section or with a far projecting cross-section in the first section into an existing chassis system with peripheral systems, which would abut against the axle tube if only the first section were present. It may be preferred that the axle tube has a plurality of second sections, in order to be able to use the axle tube also in an installation space restricted by several peripheral systems or in different chassis systems with differently arranged peripheral systems. By arranging at least a second section on the axle tube according to the invention, it is possible to design the mean cross-section of the axle tube, i.e. the average cross-section of the axle tube over the course along the longitudinal axis particularly large or projecting while preventing at the same time that the axle tube collides with peripheral systems of the chassis of the commercial vehicle. Due to the large cross-section of the axle tube, it is in particular possible to increase the area moment of inertia while keeping the walls thin. Thus, by means of an axle body designed according to the invention, the weight of the axle body may be reduced while the required bending strength and torsional strength are nevertheless realized.

Preferably, a cross-section of the first section is of plane-symmetrical design with respect to two planes or planes of symmetry intersecting in the longitudinal axis of the axle tube, wherein a cross-section of the second section is of plane-symmetrical design with respect to one of the planes and of asymmetrical design with respect to the respective other plane. The planes of symmetry of the first section are preferably perpendicular to each other, wherein the longitudinal axis of the axle tube is preferably the intersecting line resulting in the intersection area of the two planes. Preferably, when there are two planes of symmetry, the cross-section of the first section of the axle tube is of rectangular design, preferably of square design, wherein in the respective corners of the rectangle or square there are preferably provided curves both in order to facilitate the manufacture and in order to avoid stress peaks in the corner area of the axle tube. The cross-section of the second section of the axle tube is preferably of a plane-symmetrical design with respect to one plane of symmetry of the first section only and of asymmetrical design with respect to the respective other plane, i.e., to put it differently, the second section preferably has a rectangular cross-section or a cross-section deviating from the equilateral polygonal form. In the preferred case that the first section has a circular or doughnut-shaped cross-section, the second section has accordingly preferably a cross-section geometry deviating from the circular shape. In particular, the second section, with respect to the first section, is a recess, which provides for additional installation space in the proximity of the axle tube, which may be occupied by peripheral systems of the chassis of the commercial vehicle.

Particularly preferably, the first section of the axle tube has a cross-section, which is preferably substantially constant over the course of the longitudinal axis, wherein 0.4 to 0.95 times, preferably 0.5 to 0.8 times, and most preferably 0.6 to 0.7 times of the cross-section of the second section is congruent with the cross-section of the first section. In this context, the term “substantially constant” means that along the course of the first section of the axle tube there may indeed be provided small changes in cross-section such as gaps, bores or projections so that the axle tube may be fixed to further elements of the chassis or that lines may enter and exit, for example. Preferably, the cross-section of the first section of the axle tube is actually constant at least over 0.9 times the extension of the first section along the longitudinal axis of the axle tube, i.e. both the surface and the geometric dimensions thereof remain unchanged. The lower limit of the preferred relationship of 0.4 is in particular achieved when, for mounting the axle tube in an existing chassis system, a geometry of the second section is required, which deviates very considerably from the otherwise present geometry of the first section, in order to be able to insert the axle tube into the possibly limited installation space. It is also possible that a second section has several flattenings or bulges. The largest preferred relationship of 0.95 is present in particular when only a small deviation in the geometry of the first section is required in order to be able to mount the axle tube in a chassis of a commercial vehicle. As a matter of course, the smaller the deviation of the geometry of the second section from the geometry of the first section, the more undisturbedly the moments and forces develop in the material of the axle tube during bending and torsion so that the load on the material is accordingly less than in the case of great changes in the course of the cross-section. In this context, the present invention allows for a good compromise between the good utilization of the available installation space on the one hand and the optimal transmission of force or moment by means of the axle tube on the other hand.

Preferably, the second section has a second circumference, which is smaller than a first circumference of the first section. In this context, the circumference of the respective section is defined as the actual circumference of the outer geometry of the respective section measured transverse to the longitudinal axis. If the outer geometry of the first or of the second section shows deviations, the average or mean circumference is to be defined as the circumference of the respective section. In this context, the circumference may be measured also irrespective of the cross-section geometry, i.e. of a circular or polygonal geometry of the respective section, for example.

Particularly preferably, the relationship of the second circumference to the first circumference is 0.820 to 0.999, preferably 0.850 to 0.997, and most preferably it is about 0.990 to 0.995. Said preferred relationship ranges of the second circumference to the first circumference show in particular that a deviation of the geometry of the second section from the geometry of the first section is to occur in particular at the outside thereof only insofar as at the same time the area moment of inertia and, thus, the resultant modulus of resistance against bending moments and torsion moments of the axle tube is not to be unduly reduced. When observing at least the greatest range for a relationship of the second circumference to the first circumference of 0.820 to 0.999 proposed here, it is ensured that the axle body and in particular the axle tube will not be unduly weakened locally and may transmit sufficiently high bending moments and torsion moments or bending forces without the danger of material damage.

Preferably, the second section has a mean wall thickness, which is in a relationship of 1.01 to 1.3, preferably 1.03 to 1.2, and most preferably 1.05 to 1.15 to the mean wall thickness of the first section. In particular when there is the danger of a local weakening of the area moment of inertia or of the modulus of resistance of the axle body in the area of the second section, which would lead to undue material stresses, it is preferred that the wall thickness in the area of the second section is increased such that the resistance of the axle tube against bending moments and torsion moments in the area of the second section increases again. A disadvantage of increasing the mean wall thickness is the increased weight of the axle body. Therefore, the mean wall thickness of the second section should amount to not more than 1.3 times of the mean wall thickness of the first section so as not to undo again the effect caused by increasing the mean transverse extension of the axle body and the resultant reduction in the weight of the axle body by increasing the local wall thickness too much in the area of the second section. Particularly preferably, the relationship of the mean wall thicknesses with respect to each other should be kept in a relationship of 1.05 to 1.15, since thus a local increase in weight is minimized while at the same time a sufficient strength of the axle tube may be ensured in that at the same time the area of the greater wall strength is purposefully adapted according to the bending moments to be expected despite the only slight increase in weight.

Preferably, the second section has a flattening with a substantially plane surface. The plane surface of the second section makes it possible to easily arrange preferably larger peripheral system in the proximity of the axle tube, wherein at the same time, due to the surface of the flattening of the second section, which is as even and plane as is possible, the area moment of inertia or the modulus of resistance of the axle tube is not overly reduced by notches or cavities, for example, which might result in a notching effect and, thus, stress peaks.

Particularly preferably, the flattening has a width, which is in a relationship of 0.05 to 0.31, preferably of 0.1 to 0.2, and most preferably of about 0.11 to 0.12 to the first circumference. The width of the flattening of the second section, in turn, is a good compromise between a good utilization of the installation space surrounding the axle tube on the one hand and a sufficient remaining strength of the axle tube in the area of the second section and in particular in the area of the flattening of the second section on the other hand. The larger the width of the flattening relative to the first circumference of the first section of the axle tube, the deeper is necessarily also the indentation or the recess, which the second section represents with respect to the first section, and accordingly large is also the impairment of the bending strength of the axle tube in the area of the second section of the axle tube. A particularly good compromise between the good utilization of the installation space available for the axle tube and a simultaneously high strength, while the walls of the axle tube are thin, is the preferred range of 0.11 to 0.12 of the width of the flattening relative to the circumference of the first section.

It is particularly preferred that the second section has a cross-section, which is doughnut-shaped at least in a certain area. With regard to great area moments of inertia it is advantageous if the axle body of the axle tube has doughnut-shaped cross-sections or cross-section geometries over large parts of the extension thereof. Thus, for a certain wall thickness, a higher bending moment or torsion moment may be transmitted than in the case of polygonal cross-sections with the same wall thickness, for example. It is particularly preferred that also the second section has a cross-section geometry, which is similar to the first section or which is congruent in a certain section and which is in particular doughnut-shaped.

Here, it is preferred that the doughnut-shaped area of the second section occupies 0.55 to 0.9 times, preferably 0.6 to 0.85 times, and most preferably 0.7 to 0.8 times of the cross-section of the second section. Particularly preferably, the doughnut-shaped cross-section of the second section corresponds to the doughnut-shaped cross-section of the first section, wherein the cross-section of the second section deviates from the cross-section of the first section only in those areas, in which it is not doughnut-shaped. The higher the portion of a doughnut-shaped design of the cross-section of the second section of the total cross-section of the second section, the higher is accordingly also the area moment of inertia of the second section, while the wall thicknesses remain the same. At the same time, however, the local deviation from the doughnut-shaped geometry should make it possible to add peripheral systems in the area of the axle body. The described relationship of 0.7 to 0.8 of the doughnut-shaped area of the cross-section of the second section to the total cross-section of the second section is a very good compromise between a good installation space utilization by the axle tube of the axle body and at the same time a high area moment of inertia and, thus, a high resistance of the axle tube.

Preferably, the axle tube has a third section, the cross-section of which is congruent with the cross-section of the first section, wherein the second section is arranged between the first section and the third section. Preferably, thus, it is possible that the second section of the axle tube is not arranged before the outer or in the distal end region of the axle tube, but also such that the second section is still followed by a third section of the axle tube, which has a cross-section, which is preferably identical to that of the first section. For this preferred case, at the distal end of the third section, which faces away from the second section, a second transition section is arranged, which in turn serves to accommodate the axle stub.

Particularly preferably, between the first and the second sections, a first transition section is provided, wherein the first transition section has a lateral surface, which is curved substantially synclastically towards the first section and substantially anticlastically towards the second section. A synclastic or an anticlastic curvature of a surface is well-known in the prior art. In the present case, the synclastic and the anticlastic curvatures serve particularly preferably to design the surface geometry of the axle tube in the area between the first section and the second second in a manner ensuring a favorable distribution of stresses. Here, one part of the curvature of the synclastic or anticlastic curvature consists in a respective curvature about the longitudinal axis of the axle tube and the respective other part of the curvature of the transition section forms an evenly curved or rounded surface, which evenly transitions into the first or into the second section, thus avoiding stress peaks.

Particularly preferably, the synclastically curved portion of the lateral surface of the transition section is designed such that it transitions substantially tangentially into the lateral surface of the first section of the axle tube. Thus, preferably, notching effects and stress peaks resulting therefrom in the area of the lateral surface of the transition section are avoided. Further preferably, the anticlastically curved part of the lateral surface of the transition section transitions substantially tangentially into the lateral surface of the second section of the axle tube. In that the transitional surface and in particular the lateral surface of the transition section transition substantially tangentially into the lateral surface of the second section, a notching effect and stress peaks resulting therefrom are avoided in this transitional area as well. Substantially tangentially means that smaller deviations from a mathematically perfect tangency may indeed occur, which are in particular manufacture-related. Within the framework of an economic manufacture outlay, the deviations from tangency will preferably be kept so small that a high strength of the axle tube is ensured.

Preferably, the axle stub is fixed to a second transition section of the axle tube, wherein the second transition section has a doughnut-shaped end face. Preferably, the second transition section of the axle tube may be provided either on the second section of the axle tube or, if a third section is present, also on said third section of the axle tube. Irrespective of the cross-section geometry of the axle tube, i.e. whether it is doughnut-shaped or polygonal, the second transition section preferably serves to as evenly as is possible and with an even rounding lead over from said geometry to a doughnut-shaped cross-section so that the rotation-symmetrical axle stub may be easily fixed to the doughnut-shaped end face of the second transition section. Particularly preferably, the axle stub may be fixed to the second transition section of the axle tube by means of friction welding. An advantage of fixing the axle stub by means of friction welding is that the axle stub may have a manufacturing material different from the axle tube, for example, and that during the welding operation the temperatures are not so high as to cause local structural damage. Alternatively, the axle stub may also be manufactured one-piece with the axle tube, such as by a forging operation or by means of an internal high pressure forming operation.

According to the invention, there is further provided a chassis unit comprising an axle body and a peripheral system, wherein the axle body has an axle tube and an axle stub, wherein the axle tube has a first section, which is in the form of a hollow body, wherein the peripheral system may be or is arranged so close to the axle tube that it intersects an imaginary continuation of the outer geometry of the first section of the axle tube, wherein between the imaginary outer geometry and the peripheral system, the axle tube has a second section, which is spaced apart from the peripheral system. The chassis unit of the commercial vehicle is preferably the chassis area of the commercial vehicle, in which an axle body, particularly preferably the rigid axle, is mounted particularly preferably of a tractor or of a trailer of the commercial vehicle. The axle body is preferably a component in the form of a hollow body having an axle tube and an axle stub and extending substantially along a longitudinal axis. Furthermore, the chassis unit has a peripheral system, wherein the peripheral system is preferably part of a brake system, of a line system, of the anti-lock braking system sensor of a speedometer system or of any other force-transmission system of the vehicle. Preferably, the spatial extension of the axle tube transverse to the longitudinal axis is as large as is possible, in particular in order to keep the modulus of resistance or the area moment of inertia of the cross-sections of the axle tube as big as is possible and to thus achieve a high bending strength and the torsion strength of the axle tube even if the walls are as thin as is possible. Here, there would be installation space collisions between the axle tube and a peripheral system of the chassis unit of the commercial vehicle, unless the axle tube had a second section, which is designed such that the axle tube in the mounted state provides sufficient installation space, into which the peripheral system may project. Here, it is particularly preferred that a first section of the axle tube is formed substantially cylinder-shaped, i.e. either with a constant polygonal cross-section or with a circular or doughnut-shaped cross-section, which remains substantially constant along the longitudinal axis, wherein the peripheral system of the chassis unit intersects an imaginary continuation of the outer geometry, i.e. of the lateral surface of the above-described cylinder of the first section. In order to avoid a collision or contact or a crash between the axle tube and the peripheral system in this intersection area, the second section of the axle tube is provided, which, to put it differently, represents a deviation, preferably a recess, from the outer geometry or from the continued lateral surface of the first section. In that two different sections are arranged on an axle tube according to the invention, it is possible to use one and the same axle tube or one and the same axle body in different chassis units of different types of commercial vehicles since in this way also a plurality of differently formed peripheral systems of the different chassis units will not collide with the axle body. For a selected number of vehicle types, it is thus possible to provide an axle body, which uses the installation space conditions of each vehicle type as completely as is possible and, due to the large cross-section, allows for smaller wall thicknesses and, thus, a lower weight. Thus, one and the same axle body may be used for a plurality of commercial vehicle types, wherein this standardization makes it possible to save both development costs and manufacturing costs.

Preferably, the axle body of the chassis unit has further of the above-mentioned features and advantages of the axle body of the invention.

Further advantages and features of the invention become apparent from the following description of preferred embodiments with reference to the appended Figures. As a matter of course, individual features of the features shown in the embodiments may also be used in other embodiments, insofar as this has not been explicitly excluded.

### BRIEF DESCRIPTION OF THE DRAWINGS

The Figures show:

FIG. 1 shows four sectional views of a preferred embodiment of the axle body of the invention,

FIG. 2 shows four sectional views of a preferred embodiment of the axle body of the invention,

FIG. 3A shows a sectional view of a preferred embodiment of the chassis unit of the invention,

FIG. 3B shows a sectional view of a preferred embodiment of the chassis unit shown in FIG. 3A,

FIG. 3C shows a further sectional view of a preferred embodiment of the axle body of the invention, and

FIG. 4 shows a sectional view of a preferred embodiment of the chassis unit of the invention.

### DETAILED DESCRIPTION OF THE PREFERRED EMBODIMENTS

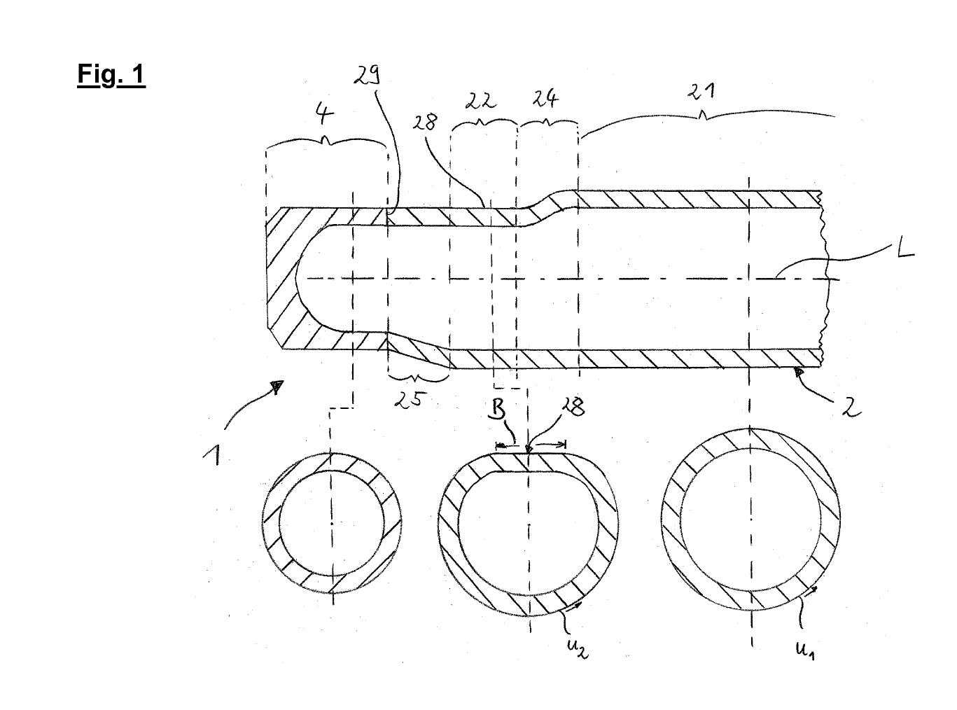

FIG. 1 is a sectional view of a preferred embodiment of the axle body 1 of the invention. The axle body 1 has an axle tube 2 and an axle stub 4, wherein the axle stub 4 is fixed to the axle tube 2 preferably by means of friction welding. The axle tube 2 has a first section 21, which has its largest extension along a longitudinal axis L and which is in the form of a hollow body. Here, the cross-section or the cross-section geometry of the first section 21 of the axle tube 2 is substantially unchanged or constant over the course along the longitudinal axis L. The first section 21 is adjacent to a first transition section 24, wherein preferably both the outer contour of the first section 21 and the inner contour thereof transition evenly or tangentially into the respective multiple-curved outer and inner contours of the first transition section 24, so as to reduce in particular the notching effect occurring at sharp edges of a body under load. Furthermore, the axle tube 2 has a second section 22, which is adjacent to the first transition section 24, and which at the distal end facing away from the first transition section 24 is adjacent to a second transition section 25. The second section 22 particularly preferably has a flattening 28, which, to put it differently, represents a recess with respect to the outer geometry of the first section 21. Finally, the axle tube 2 has an end face 29, which in the embodiment shown is an end face of the second transition section 25 and which particularly preferably is designed in the form of a circle. Preferably, the axle stub 4 may be welded to this end face 29. The axle stub 4 corresponds to an axle stub known in the prior art and serves in particular to rotatably mount vehicle wheels on the axle body 1. To this end, the axle stub 4 is rotationally symmetrical, particularly preferably rotationally symmetrical about the longitudinal axis L. Furthermore, FIG. 1 shows three sectional views of different regions or sections of the axle body 1. At the bottom of the Figure, on the right, a sectional view of the first section 21 is shown, wherein the preferably doughnut-shaped geometry as well as the first circumference U₁ running around the outer surface of the first section 21 are shown. As a matter of course, a rotation symmetry about the longitudinal axis is equivalent to a plane symmetry to a plurality of planes intersecting in the longitudinal axis. The second sectional view, which is shown in the middle, is a sectional view of the second section 22, wherein the second circumference U₂ is shown, which runs around the second section 22 preferably in a plane perpendicular to the longitudinal axis L. The second circumference U₂ is preferably smaller than the first circumference U₁. Further preferably, the flattening 28 has a width B, which is in a preferred relationship to the first circumference U₁ of 0.05 to 0.31, preferably of 0.2, and most preferably of 0.11 to 0.12. In the preferred embodiment shown here, the cross-section geometry of the second section 22 corresponds largely to the cross-section of the first section 21 and is congruent with or identical to the cross-section of the first section 21 particularly preferably in the area outside of the flattening 28 and the adjacently arranged roundings. The third sectional view of the axle stub 4 shown at the bottom, on the left of the Figure, shows that at least the outer geometry thereof is rotationally symmetrical with respect to the longitudinal axis L. As a matter of course, with the aim of an area moment of inertia of the axle body 1, which is as great as is possible, a circular or a doughnut-shaped cross-section geometry is preferred in various intersection areas since such geometries allow for a particularly high resistance against bending and torsions, while the wall thicknesses can be chosen as thin as is possible.

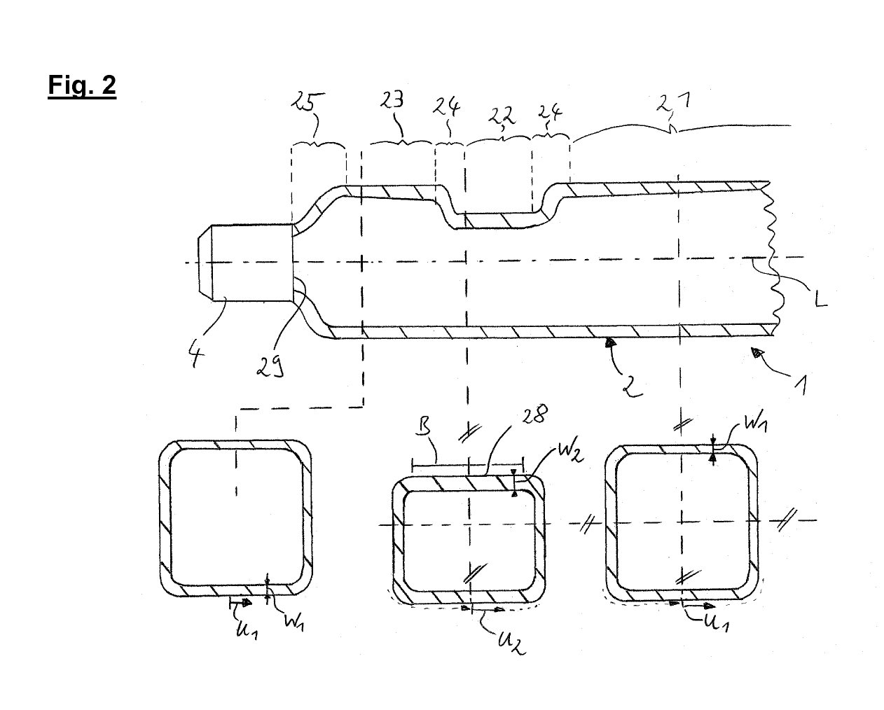

FIG. 2 shows a further preferred embodiment of the axle body 1 according to the invention. The essential difference to the embodiment shown in FIG. 1 is the polygonal cross-section of the axle tube 2 as well as the presence of a third section 23 of the axle tube 2. The axle tube 2 shown in FIG. 2 has a first section 21, which is plane-symmetrical with respect to preferably two planes, which are perpendicular to each other and which intersect in the longitudinal axis L. To put it differently, the first section 21 has a square cross-section and is in particular in the form of a hollow body. As is shown in the sectional views shown at the bottom, the second section 22 is plane-symmetrical with respect to the perpendicular plane, to which also the first section 21 is plane-symmetrical, and by contrast not plane-symmetrical to the horizontal plane, to which the first section 21 is plane-symmetrical. To put it differently, the second section 22 has a smaller vertical extension than the first section 21, so that in the area, which is left free by the second section 22, a peripheral system 6 (not shown in the Figure) may be or is arranged in the proximity of the axle tube 2, for example. Adjacent to the second section 22, on each side, a respective first transition section 24 is provided, allowing for an as even as is possible transition from the cross-section geometry of the first section 21 into the cross-section geometry of the second section 22 and, in turn, up to the cross-section geometry of the third section 23. Adjacent to the third section 23, a second transition section 25 is provided, which particularly preferably leads on from the substantially polygonal cross-section geometry or polygonal cross-section geometry provided with roundings of the axle tube to a circular cross-section or a cross-section, which is rotationally symmetrical about the longitudinal axis L. The end face 29 of the axle tube 2 is preferably doughnut-shaped, wherein the axle stub 4 may be fixed to said doughnut-shaped end face 29. In the sectional views, it is further shown that the second section 22 has a wall thickness W₂, which is on average preferably larger than the wall thickness W₁ of the first section. Said locally increased wall thickness W₂ preferably serves to achieve also in the second section 22 an area moment of inertia, which is as great as the area moment of inertia of the first section 21. Due to the smaller extension of the second section 22 transverse to the longitudinal axis L in comparison to the first section 21 the wall thickness W₂ is larger in the area of the second section 22. It is further shown that the third section 23 preferably has a cross-section geometry, which is identical to that of the first section 21. As a matter of course, adjacent to the third section 23 in the left-hand direction in the Figure, there may also be provided a second section 22, in order to be able to arrange further peripheral systems 6 (not shown) in the proximity of the axle tube 2. The wall thicknesses W₁ and W₂ are to be understood as average, mean wall thicknesses of the respective cross-section, i.e. as arithmetic mean of the wall thickness over the course parallel to the circumference U₁ or U₂.

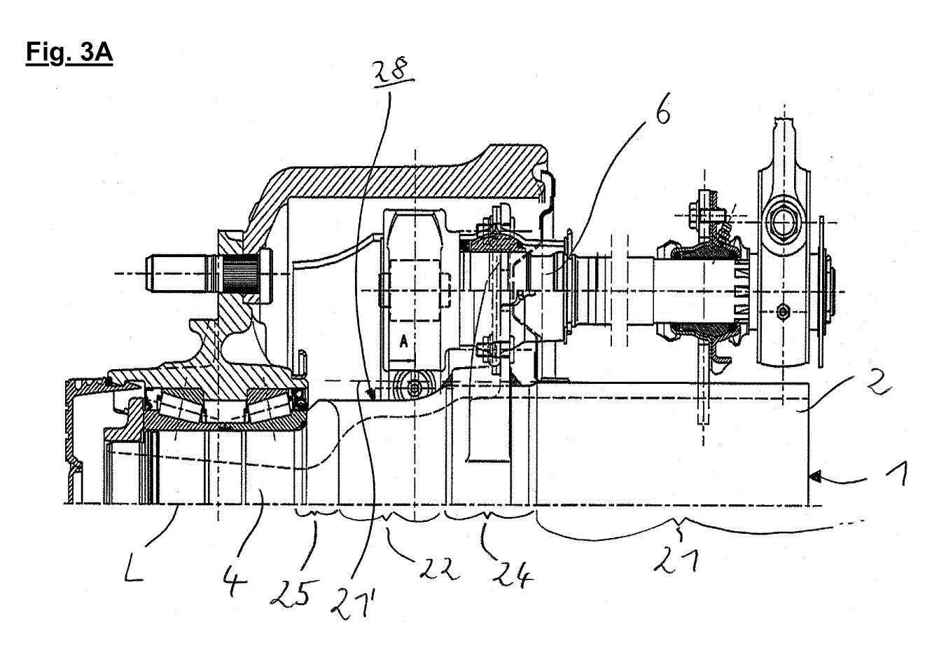

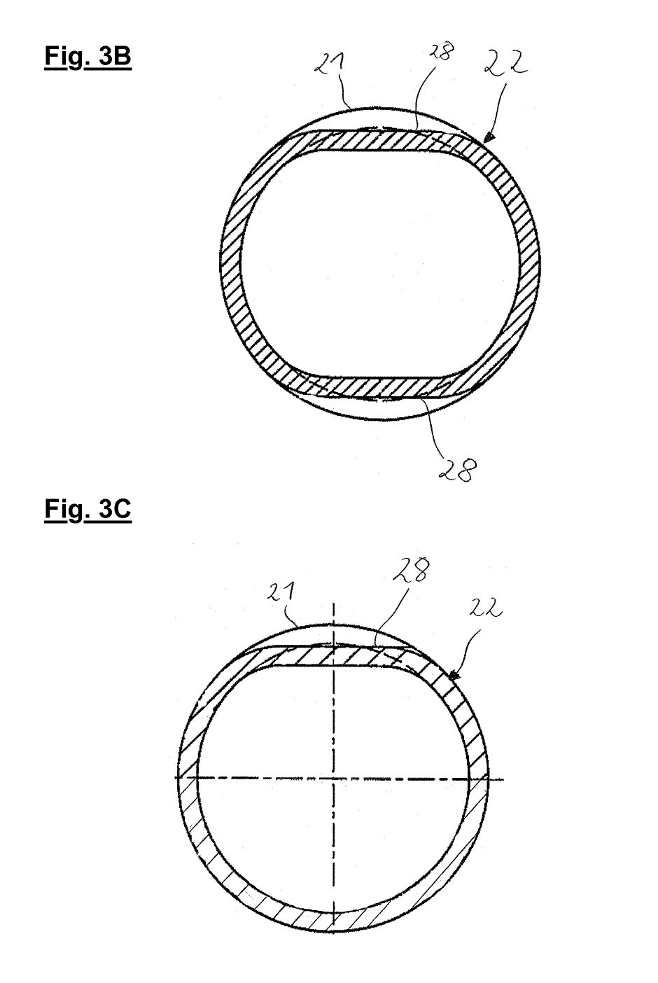

FIG. 3A shows a partially sectional view of a chassis unit with a peripheral system 6 and an axle body 1. The peripheral system 6 is preferably the actuation system of a drum brake of a utility vehicle, wherein in the area of the second section 22 said peripheral system projects preferably into an imaginary continued geometry or outer geometry 21′ (shown in dashed lines) of the outer geometry of the first section 21. In order to be able to nevertheless use for a chassis system as it is shown in FIG. 3A an axle tube 2 with an outer geometry, which is as large as is possible or as far-protruding as is possible, without giving rise to collisions between the peripheral systems 6 and the axle tube 2, the second section 22 preferably has a flattening 28. For the purpose of further illustration, FIGS. 3B and 3C show two preferred embodiments of the second section 22 of the embodiment shown in FIG. 3A of the chassis unit according to the invention. Thus, it may be preferred that at each of the two sides of the second section 22 a respective flattening 28 is provided. Alternatively and as is shown in FIG. 3C, the flattening 28 of the second section 22 may be provided at one side only. The preferred number of flattenings 28 results from the installation space conditions of a chassis unit of the invention, wherein an axle tube 2 may have a plurality of second sections 22, which when used in a certain chassis unit correspond to a lower number of peripheral systems 6, wherein when the same axle body 1 is used in another chassis unit, the respective other ones of the provided second sections 22 correspond to peripheral systems 6. Correspond means in this context that the outer geometry of the second section 22 and the peripheral system 6 are not in contact, however, that the gap therebetween is as small as is possible. Thus, the installation space provided in the chassis unit may be used as completely as is possible by an axle body 1 in the sense of the present invention.

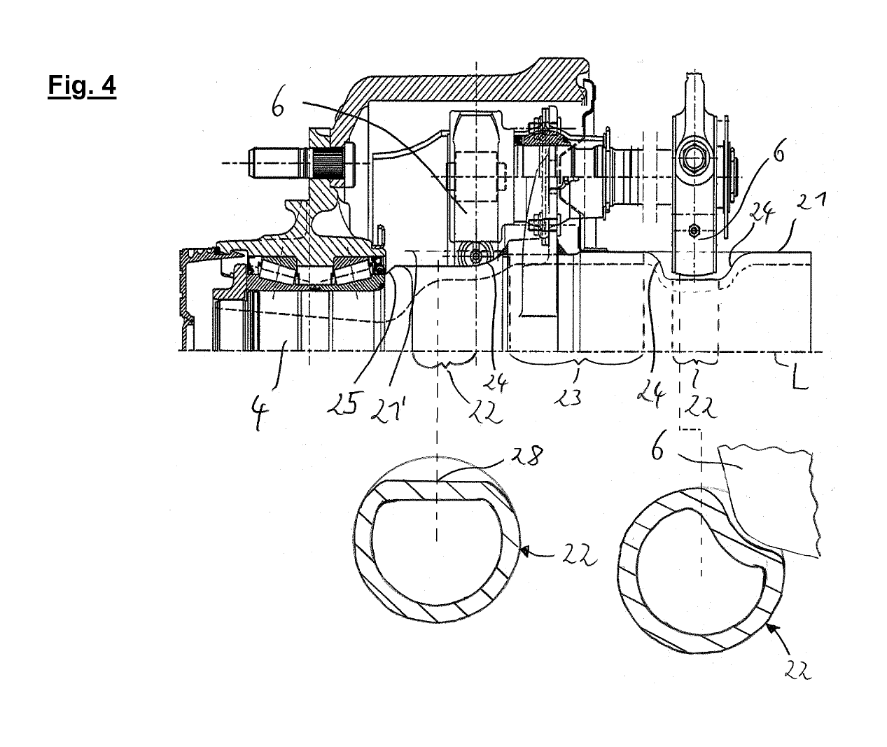

FIG. 4 shows a partially sectional view of a further preferred embodiment of the chassis unit according to the invention, wherein a peripheral system 6 is provided, which enters into or intersects the imaginary outer geometry 21′ of the first section 21 at two sites. In order to avoid a collision between the axle body 1 and the peripheral system 6 in the chassis unit in the case of the installation space conditions shown, the axle tube 2 preferably has two second sections 22, the sectional views of which are shown at the bottom in the Figure. Preferably, a second section 22 may have a local flattening 28, as is shown in the left-hand sectional view. Alternatively, there may be provided an impression in the form of a dent, the cross-section geometry of which is substantially similar to the cross-section geometry of the peripheral system 6. In the area of the second sections 22 building space for the peripheral system 6 in the area of the axle tube 1 is accordingly left free. Similar to the embodiment shown in FIG. 2, there are provided two transition sections 24 and a third section 23 between the second sections 22. Particularly preferably, the first section 21 of the axle tube 2 has an outer diameter, which is in the range of 100 mm to 160 mm, particularly preferably about 145 to 150 mm.

### LIST OF REFERENCE SIGNS

1—axle body
2—axle tube
4—axle stub
6—peripheral system
21—first section
22—second section
23—third section
24—first transition section
25—second transition section
28—flattening
29—end face
B—width
L—longitudinal axis
U₁—first circumference
U₂—second circumference
W_{1,2}—mean wall thickness

1-13. (canceled)

14. An axle body for use in motor vehicles, comprising:
an axle tube; and
an axle stub;
wherein the axle tube comprises a hollow body and has a plane-symmetrical first section,
wherein the axle tube has a second section, which is asymmetrical with respect to the plane of symmetry of the first section;
wherein the axle stub is arranged at a distal, rotationally symmetrical end of the axle tube;
wherein the second section has a second circumference, which is smaller than a first circumference of the first section;
wherein the relationship of the second circumference to the first circumference is 0.820 to 0.995; and
wherein the second section has a flattening with a substantially plane surface, and wherein the flattening has a width, which is in a relationship of 0.05 to 0.31 to the first circumference.

15. The axle body of claim 14,
wherein a cross-section of the first section is plane-symmetrical with respect to two planes, which intersect in the longitudinal axis of the axle tube; and
wherein a cross-section of the second section is plane-symmetrical with respect to one of the planes and is asymmetrical with respect to the respective other plane.

16. The axle body of claim 14, wherein the first section of the axle tube has a substantially constant cross-section, and wherein 0.4 to 0.95 times of the cross-section of the second section is congruent with the cross-section of the first section.

17. The axle body of claim 16, wherein 0.5 to 0.8 times of the cross-section of the second section is congruent with the cross-section of the first section.

18. The axle body of claim 17, wherein 0.6 to 0.7 times of the cross-section of the second section is congruent with the cross-section of the first section.

19. The axle body of claim 14, wherein the relationship of the second circumference to the first circumference is 0.850 to 0.995.

20. The axle body of claim 19, wherein the relationship of the second circumference to the first circumference is 0.990 to 0.995.

21. The axle body of claim 14, wherein the second section has a mean wall thickness, which is in a relationship of 1.01 to 1.3 to the mean wall thickness of the first section.

22. The axle body of claim 21, where the relationship of the mean wall thickness of the second section to the mean wall thickness of the first section is 1.05 to 1.15.

23. The axle body of claim 14, wherein the second section has a cross-section that is doughnut-shaped at least in a certain area.

24. The axle body of claim 23, wherein the doughnut-shaped area of the cross-section of the second section occupies 0.55 to 0.9 times of the cross-section of the second section.

25. The axle body of claim 24, wherein the doughnut-shaped area of the cross-section of the second section occupies 0.6 to 0.85 times of the cross-section of the second section.

26. The axle body of claim 25, wherein the doughnut-shaped area of the cross-section of the second section occupies 0.7 to 0.8 times of the cross-section of the second section.

27. The axle body of claim 14, wherein a first transition section is located between the first and the second sections, and wherein the first transition section has a lateral surface, which is curved substantially synclastically towards the first section and substantially anticlastically towards the second section.

28. The axle body of claim 27, wherein the synclastically curved portion of the lateral surface of the transition section transitions substantially tangentially into the lateral surface of the first section of the axle tube.

29. The axle body of claim 14, wherein the axle stub is fixed at a second transition section of the axle tube, and wherein the second transition section has a doughnut-shaped end face.

30. The axle body of claim 14, wherein the flattening has a width, which is in a relationship of 0.1 to 0.2 to the first circumference.

31. The axle body of claim 30, wherein the relationship of the width of the flattening to the first circumference is about 0.11 to 0.12.

32. The axle body of claim 14, wherein the axle tube has a third section, the cross-section of which is congruent with the cross-section of the first section, and wherein the second section is arranged between the first section and the third section.

33. A chassis unit of a commercial vehicle, comprising:
an axle body; and
a peripheral system; and
wherein the axle body has an axle tube and an axle stub;
wherein the axle tube has a first section, which is in the form of a hollow body;
wherein the peripheral system intersects an imaginary continuation of the outer geometry of the first section;
wherein, in the intersection area between the imaginary outer geometry and the peripheral system, the axle tube has a second section, which is spaced apart from the peripheral system;
wherein the second section has a second circumference, which is smaller than a first circumference of the first section;
wherein the relationship of the second circumference to the first circumference is 0.820 to 0.995;
wherein the second section has a flattening with a substantially plane surface; and
wherein the flattening has a width, which is in a relationship of 0.05 to 0.31 to the first circumference.
